(19) United States
(12) Patent Application Publication
(10) Pub. No.: US 2013/0148460 A1
(43) Pub. Date: Jun. 13, 2013

(54) PAIL AND INSERT FOR MIXING

(71) Applicant: CRIUS TECH LLC, Minnetonka, MN (US)

(72) Inventor: Mark Eliot, Minnetonka, MN (US)

(73) Assignee: CRIUS TECH LLC, Minnetonka, MN (US)

(21) Appl. No.: 13/707,078

(22) Filed: Dec. 6, 2012

Related U.S. Application Data
(60) Provisional application No. 61/568,300, filed on Dec. 8, 2011.

(51) Int. Cl. B01F 9/00

(52) U.S. Cl. CPC B01F 9/0014
USPC 366/130

(57) ABSTRACT

An insert for a pail, or a pail, that provides the ability to mix material in the pail by rotating or rolling the pail method prior to the time of use.

### RELATED APPLICATIONS

The present application claims priority to and incorporates by reference U.S. Provisional Patent Application No. 61/568,300 filed on Dec. 8, 2011.

### BACKGROUND

1. Field of the Invention

The present invention relates generally to a pail and/or a pail insert, More particularly, the present invention relates to an insert for a pail, or a pail, that provides the ability to mix material in the pail by rotating or rolling the pail.

2. Background of the Invention

A number of different products or materials are packaging for use in pails, bucket, or containers. The containers can range in size from small to large, but generally are in a range of between a quart to 10-20 gallons in size. In many, cases the products require mixing before use.

In some cases it is adequate to simply shake the container by hand. In other cases, substantially more mixing is required. Paints for example, are typically agitated mechanically prior to use, and should be stirred or mixed again if they container sits for even relatively short periods of time. One drawback of this approach, is the difficulty in mixing such substances by hand when the pail or canister is full without spilling the substance.

More viscous materials, or substances containing multiple types of materials of different viscosities or textures, heretofore have not been capable of storage and delivery in containers because they are not cable of being stirred or agitated and therefore cannot be adequately mixed. These products are therefore usually mixed on site, or require large industrial applicators for the purpose of mixing the product at the point of use. Because of the combination of different grades of material, and other reasons, it is not possible to containerize these products. The foregoing would apply to bituminous pavement maintenance or repair materials that include a mixture of asphalt emulsions, or micro-resurfacing material with Type I through IV aggregates. These so called micro-resurfacing products are subject to settling, include a high degree of different density materials, and are consequently not suitable for being stored in a pail or container. Furthermore, these materials tend to be heavy. Thus, once placed in an even modestly large pail it quickly becomes impractical to agitate or mix the material by hand.

Thus, a need exists for an improved or container for materials that need to be mixed and/or agitated prior to use.

### SUMMARY OF THE INVENTION

An object of the present invention is to provide an improved apparatus and method for mixing containerized materials.

These and other objects of the present invention will become apparent to those skilled in the art upon reference to the following specification, drawings, and claims. To that end, the present invention comprises a container having an insert with one or more paddles adapted for mixing the contents therein.

### BRIEF DESCRIPTION OF DRAWINGS

FIG. 1 is a side view of a pail of the present invention.

FIG. 2 is a top view of the pail.

FIG. 3 is a top view of an alternative pail.

### DETAILED DESCRIPTION OF THE PREFERRED EMBODIMENTS

The present invention relates to a pail or an insert for a pail that provides paddles for mixing the material in the pail. FIG. 1 shows a side view of a pail 10. The pail 10 includes conventional lid 12, and an insert 14 that comprises two paddles 16 located along the perimeter of the pail 10 and longitudinally oriented from the bottom to the top of the pail 10.

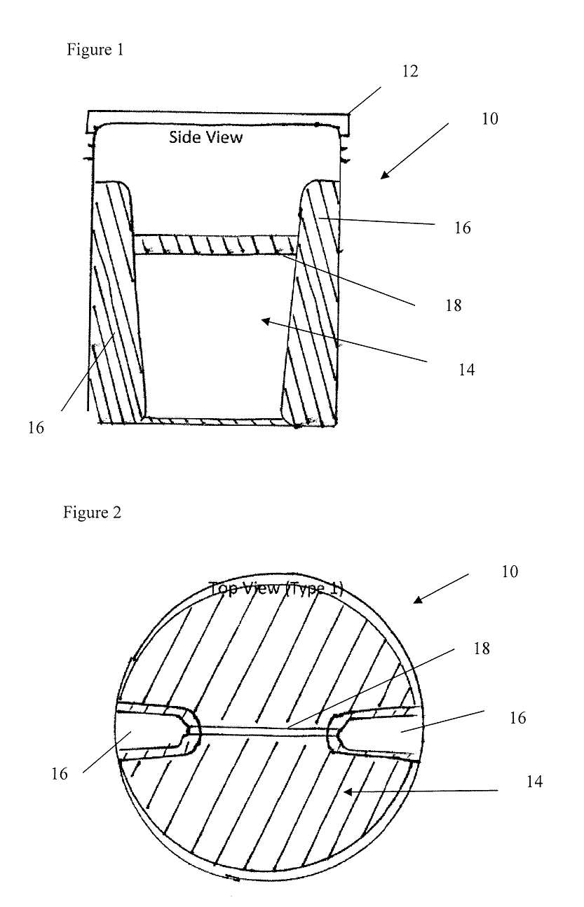

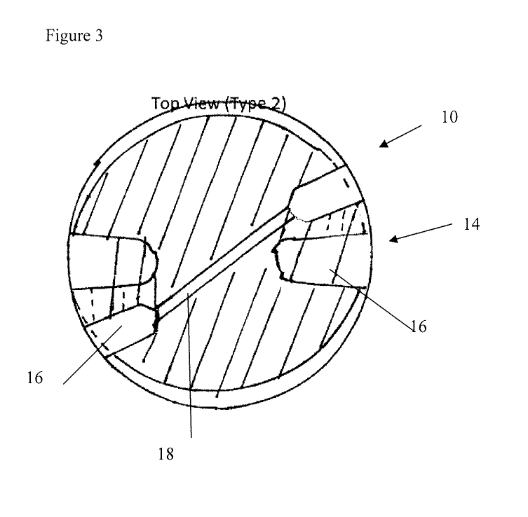

As shown in the top view of the pail 10 in FIG. 2, the paddles 16 have a transverse profile that narrows radially from the perimeter of the pail 10 toward center of the pail 10, however, the paddles 16 do not extended entirely to the center point of the pail 10. A bar 18 extends between the paddles 16 to provided some additional mixing ability, but primarily to support and stabilize the paddles 16.

FIG. 3 shows an alternative configuration of the paddles 16, wherein the paddles 16 are skewed or constructed in a corkscrew like manner. FIG. 3 shows the pail 10 from the top. The paddles twist relative to the perimeter of the pail 10 from top of the pail 10 to the bottom 10.

In practice the material in the pail can be mixed in the following manner. The insert is placed in the pail and secured, for example with glue, adhesive, or the like, or alternatively the pail can be constructed with the paddles molded or formed into the pail. It is anticipated that placing the insert in the pail after the pail is shipped to the location where pail is filled may be more advantageous. The pails would be easier to stack and ship without the insert inside. Once the pail and insert have been combined, or manufactured (as the case may be), the material is then placed in the pail and then stored until the time of use.

Prior to use of the material in the pail, the pail can be placed on its side and rolled over and over. The rolling will force the material over the paddles thereby creating agitation in the pail that will mix the material. In general the paddles are narrower at the end toward the top of the pail, which causes mixing from the bottom of the pail to the top the pail. This is especially in the case of the embodiment shown in FIG. 3, where the material will not only be agitated in an up and down fashion but will also be forced from the bottom of the pail to the top by the bottom to top by the skew of the paddles (from the perspective of the pail in the upright position). The rolling continues until the material is adequately mixed. The level of mixing can be checked by removing the lid of the container and viewing the material. If more mixing is needed, the lid can be reattached and the pail rolled further.

In this manner, the present invention substantially overcomes the problems of the prior art. In particular, the invention allows for materials that are a mix of liquid and solid material to be placed in a pail where that was not possible or practical before. The materials can be easily mixed by rolling the pail, which can be easily accomplished even if the materials are heavy and the pails large. The invention does not require mechanical means, although that can be used, and substantially eliminates the need to combine and mix such materials on site, which normally is done in bulk quantities. The material can be placed in pails and stored, shipped, and mixed at the time of use.

The invention is especially suited for, but not limited to, use with micro resurfacing products that heretofore were not able to be placed in containers because, in part, of the limitations of mixing the material. These materials are comprised of heavy Solids and liquid emulsions, and various grades of aggregate materials (Type I, II, III, IV).

While the preferred embodiment of the invention has been described in reference to the foregoing disclosure, the invention is not so limited.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A container comprising a paddle adapted for mixing the contents therein.

2. The container of claim 1 wherein the paddle are perimeter located.

3. The container of claim 2 wherein the paddle extends substantially from the bottom to the top of the container.

4. The container of claim 2 wherein the paddle narrows from the perimeter to the center of the container.

5. The container of claim 1 wherein the paddle is skewed along a longitudinal axis.

6. The container of claim 1 further comprising a lid.

7. The container of claim 1 further comprising two paddles oppositely disposed within the container.

8. The container of claim 7 further comprising a bridge between the paddles.

9. The container of claim 1 wherein the container is used to contain a substance comprised of solids and liquids.

10. The container of claim 9 wherein the container contains a resurfacing product.

11. A container comprising:
a container body;
a lid adapted for releasable securement to the container;
two paddles oppositely disposed along the perimeter of the container, narrowing from the perimeter toward the center, and skewed along a longitudinal axis, for containing a resurfacing product.
